(19) United States
(12) Patent Application Publication
(10) Pub. No.: US 2003/0035532 A1
(43) Pub. Date: Feb. 20, 2003

(54) Web-based distributed call center architecture

(75) Inventors: Suresh Ganesan, Southplainfield, NJ (US); Jeffery D. Garratt, Holly Springs, NC (US)

Correspondence Address: Jeanine S. Ray-Yarletts, IBM Corporation T81/503, PO Box 12195, Research Triangle Park, NC, 27709, US

(73) Assignee: International Business Machines Corporation, Armonk, NY (US)

(21) Appl. No.: 09/932,368

(22) Filed: Aug. 17, 2001

(51) Int. Cl. H04M 3/00; H04M 5/00

(52) U.S. Cl. 379/265.04; 379/266.01

(57) ABSTRACT

Methods, systems, computer program products, and methods of doing business by improving automated processing of customer contact requests such as telephone calls, wherein incoming contact requests (including voice and corresponding data, if any) are programmatically routed to an available customer service representative (“CSR”). A distributed architecture is defined for call center operation, which enables CSRs to access the call center using thin-client devices and also to move about from one physical location to another, yet still be able to access the call center and handle incoming calls. The CSRs may therefore be remotely located. The call center system stores information regarding the CSR's current location, and uses this information when routing customer contact requests.

### BACKGROUND OF THE INVENTION

1. Field of the Invention

The present invention relates to a computer system, and deals more particularly with methods, systems, computer program products, and methods of doing business by improving automated processing of customer contact requests such as telephone calls, wherein incoming contact requests (including voice and corresponding data, if any) are programmatically routed to an available customer service representative.

2. Description of the Related Art

The term “call center” is conventionally used to refer to a centralized location where incoming telephone calls for a business enterprise are received, and are routed to customer service representatives for processing. Call centers are commonly used by enterprises such as catalog ordering centers, insurance company claim centers, service or repair centers, and other types of businesses which receive a large volume of telephone calls. Typically, automated techniques known as “computer telephony integration”, or “CTI”, are used in the routing process, where CTI includes software and hardware components to direct the call to an appropriate destination.

When customer interaction with a customer service representative, or “CSR”, is required, incoming calls may be placed into a queue. (A CSR may be referred to equivalently as an “agent”.) A call center system may be set up to work with one queue for all incoming calls, or with multiple queues. As an example of using multiple queues, a catalog ordering company might queue callers who wish to place new orders in one queue, and callers who need to talk to a CSR about an existing order in another queue. As another example, one queue might be used for callers who speak one language (and therefore wish to speak to a CSR in that language), while another queue is used for callers who speak a different language. The queues used by the call center system are sometimes referred to as “Automatic Call Distribution”, or “ACD”, queues. Each queued call is automatically dispatched to an available CSR. A large enterprise may have tens or even hundreds of CSRs working at any given time. Enterprise-specific handling instructions or rules may be used to determine which CSR (or which group of CSRs) may handle a selected call. When a CSR finishes handling one incoming call and places his or her phone back on-hook, a signal is typically sent to the automated call routing process that this CSR is now available for handling another call.

Many call centers use interactive voice response unit (“IVRU”) technology or DTMF (dual-tone multi-frequency) key sequences to prompt the caller as to the type of information he or she needs, or the particular department to which the incoming call should be directed, etc. This input information may be used to determine, inter alia, which queue the call should be placed into while awaiting an available CSR.

In recent years, call centers are sometimes set up to handle incoming electronic mail or “e-mail” messages and/or Web-based interactions (either in addition to, or instead of, incoming telephone calls). These types of systems handle calls which originate from a customer's computer and not from just a telephone line.

However, there are situations in which existing call center operation systems are less than optimal. For example, call centers may employ CSRs who are specially trained in particular areas or who work in specific departments, and who are therefore better suited to handle some of the incoming calls than other differently-trained CSRs. A request to speak to a CSR (including data, if any) in a particular department must be sent to a workstation and telephone device where there is a CSR capable of handling the call. In a large company such as the International Business Machines Corporation (“IBM”), for example, the customer service center for computer hardware is staffed by experts on different types of computers. If a caller is having trouble with an aspect of a mainframe computer, the call is routed to a mainframe expert and not to an expert on personal computers or handheld computers.

Using the automated call routing process for routing calls to a workstation where an expert is thought to be available works well if the CSR is actually available and stationed at that workstation. However, in the traditional call center framework, if a CSR who is trained to handle the caller's request is not at the workstation to which the call is routed, then either an unqualified CSR—or worse yet, no one—would take the call. Customer service is increasingly viewed as an important differentiator in a competitive marketplace, and thus an enterprise cannot afford substandard performance in its call center operations.

Furthermore, to the best of the inventors' knowledge, existing call center systems require CSRs to be physically located at the site where the call center system technology is located. In some call centers, all CSRs may be located in a single common workspace. In other call centers, CSRs who service particular types of calls might be located on one floor of the building which houses the call center, while CSRs who service other types of calls are located on other floors of that building; however, all CSRs are located in very close proximity to the call center system itself This location requirement prevents CSRs from participating in the call routing process if they are not stationed at a local workstation.

Accordingly, what is needed is a technique that avoids the limitations of prior art call center systems.

### SUMMARY OF THE INVENTION

An object of the present invention is to provide a technique that avoids the limitations of prior art call center systems.

Another object of the present invention is to provide a distributed call center environment in which a CSR's location may vary over time without hindering call center operations.

Still another object of the present invention is to provide a technique which enables customer service representatives to move about from one workstation to another, yet still be able to handle incoming calls.

Yet another object of the present invention is to provide a technique for programmatically routing incoming customer contact requests to a customer service representative without requiring customized software to be installed on the CSR's computing device.

Other objects and advantages of the present invention will be set forth in part in the description and in the drawings which follow and, in part, will be obvious from the description or may be learned by practice of the invention.

To achieve the foregoing objects, and in accordance with the purpose of the invention as broadly described herein, the present invention provides methods, systems, and computer program products for automated processing of customer contact requests. In one aspect, this technique comprises: receiving location information from a particular CSR indicating where the particular CSR is currently located; receiving one or more incoming customer contact requests for which CSR interaction is indicated; and routing selected ones of the received customer contact requests to the particular CSR using the received location information. This technique may further comprise receiving revised location information from the particular CSR, wherein the revised location information indicates a different location where the particular CSR is now located; and subsequently routing selected ones of the received customer contact requests to the particular CSR using the received revised location information.

The location information from the CSR is preferably received over a network connection between a processing device used by the CSR and a remotely-located server. The processing device used by the CSR may be a thin-client device. The CSR typically interacts with a Web page to transmit the received location information and to handle the routed customer contact requests.

Preferably, the received location information is stored for use by the routing operation. In this case, the technique preferably further comprises creating a cookie which contains stored information for the particular CSR, and transmitting the cookie to the CSR over the network connection.

The received location information may indicate a device which is in use by the particular CSR, and to which the routing operation should route the selected ones for the particular CSR. Or, the received location information may indicate a geographic location of the CSR, or an alternative type of a physical location of the CSR.

The technique may also further comprise obtaining customer-specific information pertaining to the selected ones of the received customer contact requests, and forwarding the obtained customer-specific information to the particular CSR when routing the selected ones of the received customer contact requests.

In another aspect, the present invention provides distributed call center operations, comprising: receiving, over a network connection to a call center system, location information from one or more CSRs indicating where each of the CSRs is currently located; receiving, at the call center system, one or more incoming customer contact requests for which CSR interaction is indicated; queuing, at the call center system, each of the received customer contact requests until a CSR is available for handling the request; and routing, by the call center system, a selected one of the queued customer contact requests to a particular CSR using the received location information when the particular CSR is or becomes available. The technique may further comprise: receiving revised location information from one or more of the CSRs, wherein the revised location information indicates a different location where the CSR sending the revised location information is now located; and subsequently using the received revised location information when routing a newly-selected one of the queued customer contact requests to one of the CSRs who sent revised location information.

The present invention may also be used advantageously in methods of doing business, for example by providing improved call center systems wherein the customer contact requests are capable of being handled by CSRs whose physical location may change dynamically.

The present invention will now be described with reference to the following drawings, in which like reference numbers denote the same element throughout.

### BRIEF DESCRIPTION OF THE DRAWINGS

FIG. 1 is a block diagram of a multi-tier application architecture which is preferably used by the present invention;

FIG. 2 is a flow diagram illustrating the flow of information between components of a preferred embodiment of the present invention;

FIG. 3 provides a flowchart illustrating logic which may be used to implement processing (largely in a Web application layer) of a preferred embodiment of the present invention;

FIG. 4 provides a flowchart illustrating operations of a preferred embodiment of the present invention, according to a caller's perspective; and

FIG. 5 is a block diagram illustrating, at a high level, the components and flow of information of a preferred embodiment of the present invention.

### DESCRIPTION OF PREFERRED EMBODIMENTS

The present invention provides an improved technique for automated processing of customer contact requests by integrating a distributed Web-based architecture with call center systems. CSRs are then free to use any available workstation for communicating with the call center, even those workstations which may be distributed over long distances. After a CSR logs in to the call center system as disclosed herein, the system is then aware of the CSR's location and can properly route incoming customer contact requests to an appropriate CSR, regardless of where he or she may be physically located at the time. According to preferred embodiments, existing call center call routing technology can be used for routing calls to CSRs after the techniques of the present invention have established the CSR's location. Furthermore, the computing devices (or, equivalently, the processing devices) of the CSRs do not need to include customized software for interoperating with the call center system: instead, commercially-available user agent software such as a browser is preferably used on the CSR's workstation. In this manner, use of the present invention adds no footprint to the typical CSR computing device.

The customer contact requests contemplated by the present invention may include telephone calls and/or Web-based interactions. As an example of Web-based interactions with customers, an input request may be generated by a customer filling out a form and transmitting this form to a designated URL (Uniform Resource Locator) which is served by the call center system. CSRs who handle incoming customer contact requests (referred to equivalently herein as “incoming calls”) using the techniques of the present invention connect to the call center system using a distributed computing network which, for purposes of illustration, is described herein as the public Internet and the subset thereof known as the “Web”. (Alternatively, the CSRs may connect to the call center system using other types of networks, including but not limited to extranets or private intranets. It will be obvious to one of ordinary skill in the art how the teachings herein may be adapted to these other networking environments.) CSRs are therefore no longer limited to being physically located on the same premises as, nor in physical proximity to, the site where the call center technology is located. In this manner, the flexibility of call center operations is greatly improved over existing techniques. The ability for CSRs to participate in call center operations from remote locations will accommodate working from customer sites (for example, when the CSRs handle repair or service calls), telecommuting, and other types of alternative work styles.

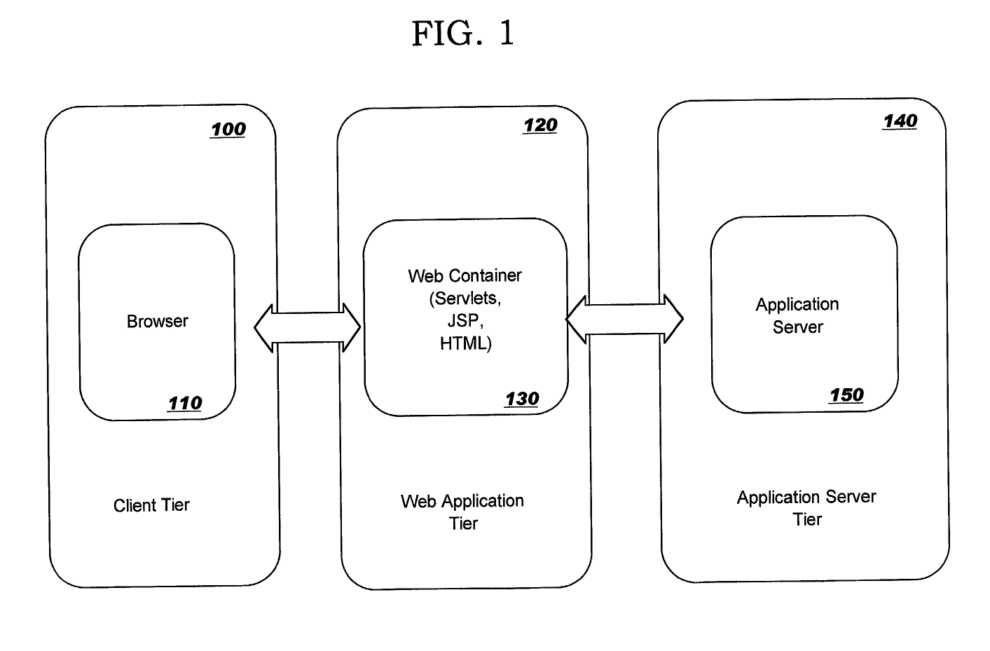

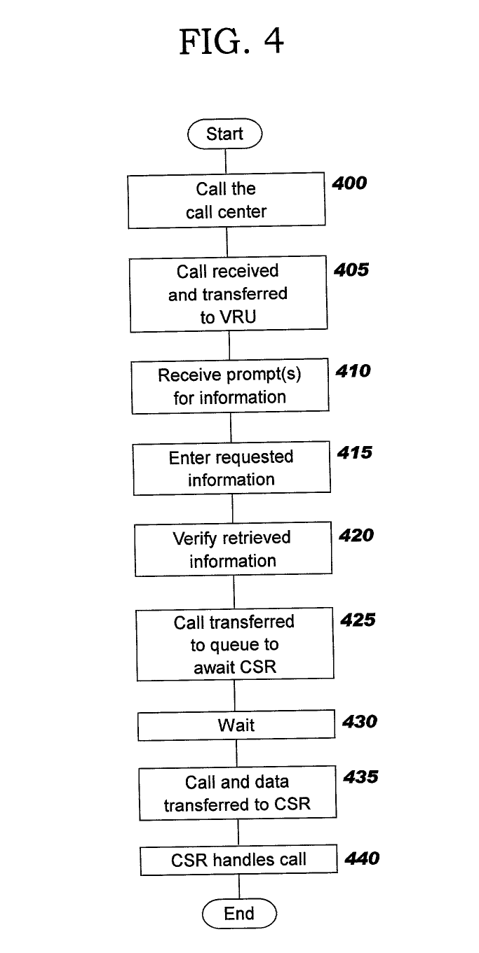

A block diagram of a multi-tier application architecture which is preferably used by the present invention is illustrated in FIG. 1. Client tier 100 includes a user agent such as browser 110. This client tier represents the workstation or computing device of a CSR; the client side of Web-based interactions with customer devices is not illustrated in FIG. 1. (See FIG. 4 for a description of processing with reference to the customer.) Client tier 100 is operatively connected (e.g. using message exchanges over a network connection) to a tier 120 that is referred to herein as a Web application tier (and which is also referred to equivalently herein as a “Web application layer” or “WAL”). This Web application tier 120 is logically positioned between the client tier 100 and a back-end application server tier 140. (Note, however, that the tiers are not strictly required to be implemented on distinct devices. There may be cases in which client tier 100 is co-located with Web application tier 120, such as when a Web application server includes a user interface that is usable by one or more CSRS. There may also be cases in which Web application tier 120 is co-located with application server tier 140.)

According to preferred embodiments, Web application tier 120 serves to:

(1) provide coordination between the browser 110 in the client tier 120 and the back-end application services provided by one or more application servers 150 which are located in the application server tier 140; and

(2) generate the presentation of information which is to be delivered to browser 110 after operation of the application service(s) in application server tier 140.

Web application tier 120 comprises one or more types of executable code, depicted generally in FIG. 1 as Web container 130. In preferred embodiments, this executable code may be a servlet, a JavaServer Page (“JSP”™), and/or a Hypertext Markup Language (“HTML”) page (or combinations of one or more of these). Application server tier 140 is responsible for obtaining information from back-end systems for use by a CSR as he or she handles an incoming call. This may comprise accessing one or more databases or other information repositories and/or executing application logic, and will be described in more detail herein. (“JSP” is a trademark of Sun Microsystems, Inc.)

Using this architecture and the techniques disclosed herein enables CSR mobility, wherein the CSR may move from location to location even within a thin-client environment. (“Thin client” refers to use of computing devices or processing devices which have a minimal amount of installed hardware and software functionality, and which typically provide services to a user by contacting a server application, where the server application provides the bulk of the computing operations. A thin client is an alternative to a full-function client such as a personal computer. Note, however, that the present invention may be used equally well with full-function clients.) In this manner, CSRs are no longer tied to a specific workstation, and may work from virtually any location. A CSR preferably uses a commercially-available computing device or processing device (referred to hereinafter as a “computing device”), which includes a personal computer, handheld computer or palm device, desktop computer, Web-enabled cellular phone, or any other device which is capable of accepting user input and rendering information, as well as communicating over a network connection. Such devices are well known in the art, and a detailed description thereof is not deemed necessary to an understanding of the present invention.

Preferably, with the exception of conventional call center system hardware (such as the call routing switch), aspects of the present invention are implemented in software, although a combination of software and hardware may be used alternatively. For purposes of discussion, it will be assumed that the aspects of the invention are implemented in software. Software programming code which embodies the aspects of the present invention is typically accessed by a central processing unit (“CPU”) of a server, mainframe, or other computing device (referred to hereinafter as “the server” for ease of reference) including the server on which Web application tier 120 resides. This programming code may be retrieved from long-term storage media of some type, such as a CD-ROM drive or hard drive. The software programming code may be embodied on any of a variety of known media for use with a data processing system, such as a diskette, hard drive, or CD-ROM. The code may be distributed on such media, or may be distributed from the memory or storage of one computer system over a network of some type to other computer systems for use by such other systems. Alternatively, the programming code may be embodied in the memory of the server, and accessed therefrom by the CPU (e.g. using a system bus). The techniques and methods for embodying software programming code in memory, on physical media, and/or distributing software code via networks are well known and will not be further discussed herein.

A CSR's computing device may be connected to the server on which WAL 120 resides using a wireline connection or a wireless connection. Wireline connections are those that use physical media such as cables and telephone lines, whereas wireless connections use media such as satellite links, radio frequency waves, and infrared waves. Many connection techniques can be used with these various media, such as: using a modem of the CSR's computing device to establish a connection over a telephone line; using a LAN card such as Token Ring or Ethernet; using a cellular modem to establish a wireless connection; etc. The CSR's computing device may be any type of processor, such as those described above, having processing and communication capabilities. The remote server, similarly, can be one of any number of different types of computer which have processing and communication capabilities. These techniques are well known in the art, and the hardware devices and software which enable their use are readily available.

In preferred embodiments, the software aspects of the invention will be implemented using object-oriented programming language(s) and techniques. However, the software aspects of the invention may alternatively be implemented using conventional programming languages that are not object-oriented, without deviating from the inventive concepts. Use of terms of object-oriented oriented programming herein is not to be construed as limiting the invention to object-oriented techniques.

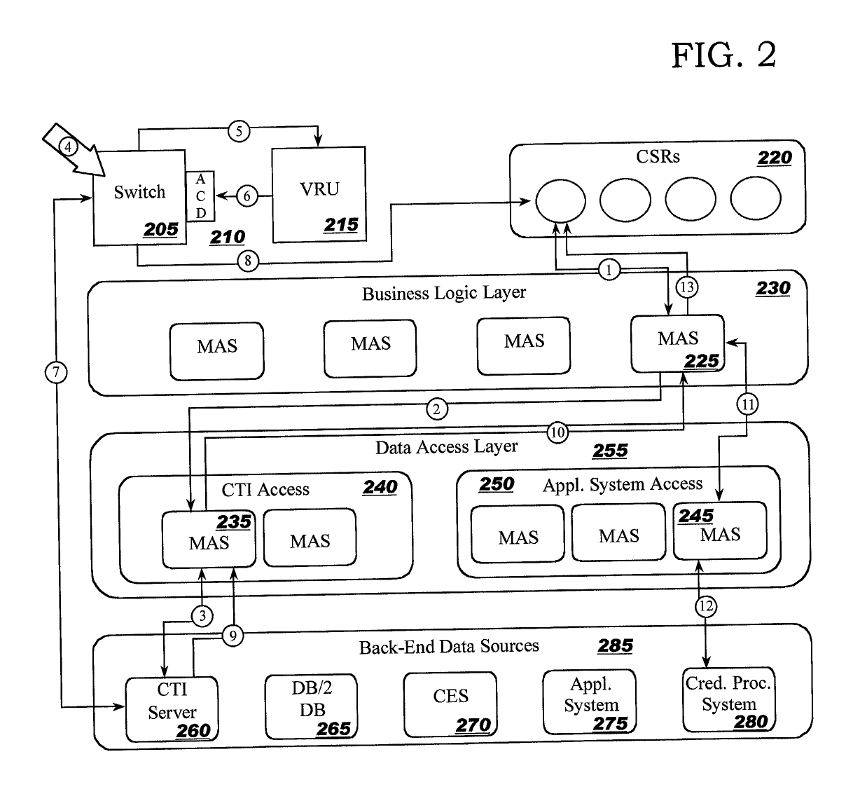

Preferred embodiments of the present invention will now be discussed in more detail with reference to FIGS. 2 through 5.

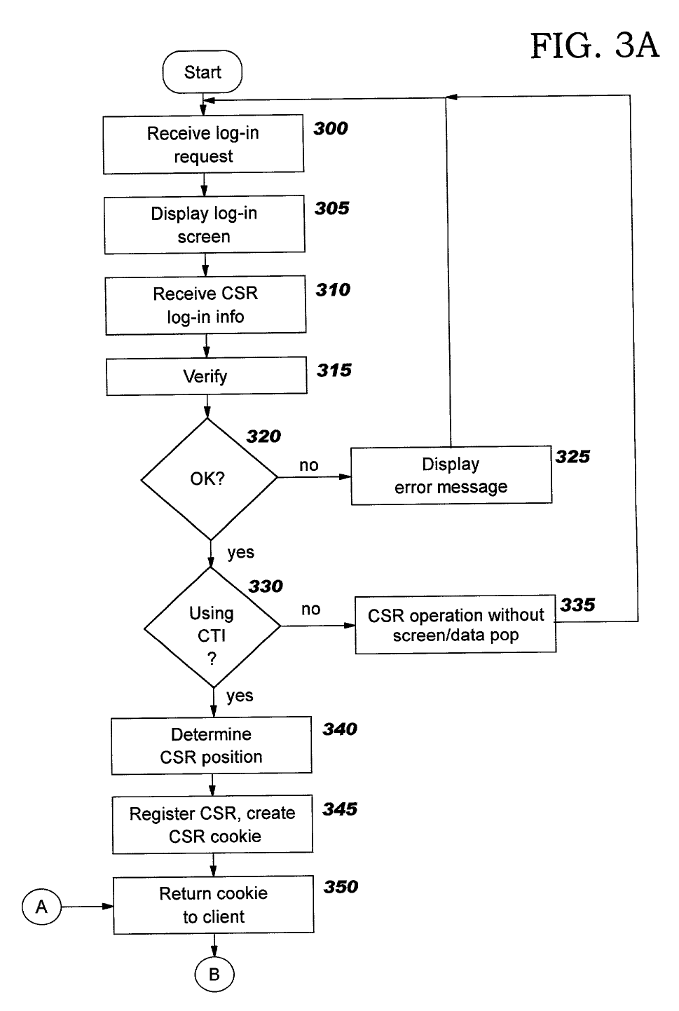

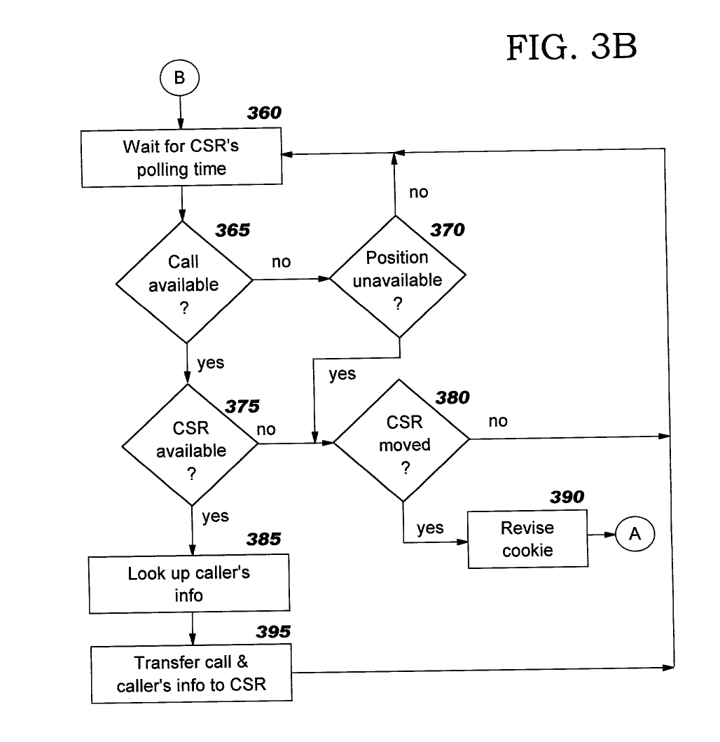

The flow diagram in FIG. 2 illustrates the flow of information between components of a call center in a preferred embodiment of the present invention. Encircled numbers are used in FIG. 2 to denote information flow, whereas numbers which are not encircled denote components. Logic underlying this processing is described in more detail with reference to FIG. 3.

The flow in FIG. 2 begins with a CSR 220 declaring that he or she is ready to receive an incoming call. With reference to the architecture of FIG. 1, this declaration preferably comprises using browser 110 to send a call request to Web application tier 120. (Alternatively, a request may be transmitted in another manner, such as by the CSR dialing an appropriate phone number associated with the call center system.) As shown by encircled element 1, a corresponding call request is passed from the Web application tier 120 to a component in the application server tier 140, where this component is designated in FIG. 2 as a Monitor Application Server, or “MAS” 225, in a business logic layer 230. (In preferred embodiments, business logic layer 230 and data access layer 255, described below, are elements of the application server tier 140.)

The function of business logic layer 230 is to implement the business processing for this particular call center. As one example, if the call center serves an insurance agency, then business logic layer 230 may be responsible for distinguishing between requests for various types of insurance policies, and ensuring that appropriate information regarding each type of policy is communicated between the CSR and the back-end application server(s). As another example, if the call center serves a bank, then business logic layer 230 may be responsible for determining whether the caller's request pertains to a checking account, savings account, mortgage loan, consumer loan, and so forth; based on this determination, the business logic layer is also preferably responsible for ensuring that the pertinent information for that account type is requested from the caller, and for ensuring that the proper information corresponding to a request for that account type is obtained from the back-end application server(s). To explore this scenario in more detail, suppose the caller's request is for information about a mortgage loan. The pertinent information to be obtained from the caller includes the loan number and typically some type of password or other security protection, while the corresponding information to be presented in response typically includes a payment due date. On the other hand, if the caller's request is for information about a savings account, payment due date is irrelevant.

One or more MAS components may be present in the business logic layer, depending on the needs of a particular implementation of the present invention. In the banking scenario, for example, one MAS may provide services for checking account information, while another provides services for savings accounts and yet another provides services for loans. The MAS 225 component performs the business logic validations, according to the needs of a particular application, and when all validations are successfully completed, communicates with MAS components in the data access layer 255.

As shown by encircled element 2, the call request is communicated from MAS 225 in business logic layer 230 to an MAS 235 in a component which is designated in FIG. 2 as “CTI Access” component 240. CTI Access component 240 is located in a data access layer 255. CTI Access component 240 serves to connect to one or more software server components, where the software server component is capable of detecting and notifying occurrence of different kinds of telephony events. For example, these telephony events might include (a) a conference call request is initiated; (b) a call transfer went through successfully; (c) an incoming call arrived. Data access layer 255 is responsible for interfacing with the back-end application sources 285. These sources include, by way of illustration, a CTI server 260, a database such as a DB/2® database, and a CallPath® Enterprise Server (“CES”) 270. A generalized application system 275 and a credit processing application system 280 are also shown in FIG. 2 to illustrate other types of potential servers. These servers could alternatively be any system(s)/application(s) providing relevant application data. The system 280 could, for example, be used to obtain credit card-related information from an application or database. To illustrate this use, the calling customer or the CSR might request a transaction such as “retrieve the last 4 transactions for credit card XXX . . . ”, where system 280 might then be responsible for obtaining and returning that information. (“DB/2” is a registered trademark of IBM. CallPath was formerly an IBM licensed program;

product ownership has recently been transferred to Genesys Telecommunications Laboratories. “CallPath” is a registered trademark.)

Upon receiving the communication from MAS 225, MAS 235 invokes logic to register the CSR, declares the CSR as being available to receive incoming calls, and then waits for a predetermined period of time (such as 30 seconds) for an incoming call event to be received for that CSR. This processing is described in more detail with reference to FIG. 3, and involves interactions between MAS 235 and CTI server 260, as shown by encircled element 3.

At some point, an incoming call arrives at the telephony switch 205, as shown by encircled element 4. In preferred embodiments, switch 205 is a commercially-available switch such as a Meridian switch from Nortel Network Corporation. The switch 205 notifies VRU 215 of the incoming call, as shown by encircled element 5. Using enterprise-specific rules or processing instructions, the VRU 215 then prompts the caller (not shown in FIG. 2) for parameters such as the type of request and other data which is associated with that request type. For example, if the caller wishes to hear mortgage loan rates from the call center of a bank, then the request type is mortgage loan rates and the other data (if any) for which the VRU prompts the caller may include asking whether the caller wishes to speak to a mortgage loan consultant; wishes to hear an automated announcement of all available rates, or perhaps just the rates for loans having a certain range of discount points, a certain term, or a certain principal amount; and so forth.

In some cases, the incoming call may be handled without CSR intervention. If, however, the information obtained from VRU 215 indicates that CSR intervention is required, then the call is returned to the ACD queue in the switch (or, alternatively, a queue which is maintained independently of the switch and which is serviced by CTI logic), as shown by encircled element 6.

When a CSR is available (or becomes available) for handling the queued call, the CTI server 260 is notified that the queued call is being assigned to that CSR, as shown by encircled element 7. CTI server 260 obtains call data when it is notified by the switch 205, where this call data may include information such as the customer account number, request type, and other parameters which were obtained by the VRU 215. Element 8 indicates that the call is then routed from the queue to the workstation of the designated CSR 220.

The CTI server 260 sends a notification event (see encircled element 9) to all MAS processes 235 in the data access layer 255 which are waiting for events on behalf of the designated CSR. (When MAS server 235 registers the CSR, it declares him or her to be available to receive calls, and then waits for a predefined period of time for events to arrive for that CSR. These events could be that a call is connected, a conference call request is made, transfer of a call is complete, and so forth. All the MASs will be waiting for these types of events, but there will only be one MAS 235 at any point in time which is waiting for specific events to arrive for a particular CSR. This mechanism works based on an active thread from MAS 235 which keeps running continuously until the event arrives.) In response, the MAS process 235 retrieves the appropriate call data from CTI server 260 (such as the customer account number, request type, and other parameters which were obtained by VRU 215, as discussed above), packages that data into a response message, and delivers the response message to the business MAS 225 (see encircled element 10).

The business MAS 225 then requests information from the back-end data sources 285 which is pertinent to this caller's request (see encircled element 11) using application-specific logic. This request is sent from MAS 225 in business logic layer 230 to an MAS 245 in a component which is designated in FIG. 2 as “Application System Access” component 250. Application System Access component 250 is located in data access layer 255, and serves to connect to application-specific data resources. MAS 245, in turn, contacts the application-specific data resource (which in the illustrated case is credit processing application system 280, which in this example is a specific applications server component capable of getting application-specific data related to credit cards.)

When using a CTI product such as CallPath, the calling number or other identifying information which was provided by the caller (for example, through the IVRU or DTMF input) may be used to automatically retrieve various types of stored information about the caller. In the case of an insurance company's claim center, for example, the caller may have been prompted to provide a policy number and perhaps additional information such as whether the request pertains to life insurance, health insurance, property insurance, and so forth. This input can be used to access a back-end data store to programmatically retrieve the caller's policy records; when the call is routed to a CSR, the retrieved information can be automatically displayed (or otherwise rendered) for use by the CSR in handling the call. This automatic refresh of the CSR's workstation is commonly known as a “screen pop”.

After obtaining stored information about the caller using CallPath or similar data retrieval software, this information is returned (see encircled element 12) from the back-end data source through MAS 245 and MAS 225 to the CSR's workstation (see encircled elements 11 and 13). Ideally, the information is automatically rendered at the CSR's workstation simultaneously with the CSR beginning to converse with the caller. The rendered information preferably serves to personalize the interaction and/or reduce the amount of information which must be provided by the caller, thereby giving the caller a sense of better customer service. For example, if the caller has entered an account number or other identifying information, then the information retrieved from the back-end data sources preferably comprises at least the caller's name and address; the caller then needs only to confirm this information, rather than taking the time to spell his or her name to the CSR and provide detailed address information. More detailed caller-specific information might also be provided, depending on the call center implementation. If the call center represents an enterprise's repair service, for example, the caller's account number might be used to retrieve details of the product(s) registered to this caller, and potentially other information about known defects in these products or extended warranty programs which the CSR might market to the caller, and so forth.

Referring now to FIG. 3, a flowchart is provided to illustrate logic which may be used to implement processing of a preferred embodiment of the present invention. This logic pertains primarily to operations in the WAL (see element 120 in the architecture of FIG. 1). Beginning at Block 300, a log-in request is received from a CSR. A log-in screen (or comparable information retrieval request) is then preferably sent to the CSR's workstation (Block 305). After the log-in screen is rendered for the CSR, and the CSR has entered log-in information, the information is received back at the WAL (Block 310). In alternative embodiments, if a thin client environment is not in use, it may be preferable to install logic on the CSR's workstation which displays (or otherwise renders) a locally-stored log-in screen and accepts data therefrom, rather than requesting the WAL to deliver this screen as depicted in Blocks 300 and 305.

Preferably, the communication between the CSR's client 110 and the WAL 120 uses a protocol such as the Hypertext Transfer Protocol (“HTTP”), which is well known in the art.

When the CSR provides log-in information at Block 310, he or she also typically logs in to the ACD; this is preferably accomplished by entering information into his or her telephone device. The log-in information may include: his or her position identifying information (i.e. information that enables the call routing process to route calls to this particular CSR at a specific location); agent identifying information (such as a code number associated with this person); and, when multiple queues are supported, identifiers of different queues for which he or she will handle call requests. The entered information may also specify a priority value for each of the multiple queues. For example, in a bank's credit card call support center, a particular CSR might indicate that he or she logs into the Englishlanguage queue with priority 1 (1 being the highest priority) and logs into the Spanish-language queue with priority 2. Typically, queues are set up in the ACD and have associated identifiers which are referenced in the CSR log-in process.

Once the CSR's log-in information has been received, it is preferably verified (Block 315), for example to ensure that this is actually a trusted user. Block 320 checks the results of this verification. If unsuccessful, then an error message is preferably returned to the CSR's workstation for rendering to the CSR (Block 325), after which control returns to Block 300 to await the next log-in request. If the verification is successful, on the other hand, processing continues at Block 330 which checks to see if this CSR is using CTI.

Some CSRs might not be required to use CTI, or it may happen (for example, for administrative reasons) that the CTI system could be taken out of service temporarily, in which case CSRs do not use CTI. When the CSR indicates that he or she will be using CTI, the system knows that this specific CSR is ready to use CTI and hence calls can be routed (with their corresponding data) to him or her. If CTI is not used, on the other hand, then only voice calls will be routed to this CSR's phone and there will not be any programmatic pop-up of corresponding data rendered on the CSR's device or workstation. (In this case, the CSR must explicitly ask the caller for all the information, and will have to manually key that data into an entry screen or form and then wait for corresponding customer information to be retrieved.)

If CTI is not in use, control transfers to Block 335 which indicates that regular CSR operations commence, without availability of screen/data pop information. Control then returns to Block 300 to await the next incoming CSR request. If CTI is in use, on the other hand, then processing continues at Block 340, where the CSR's current position is determined. A number of alternative techniques may be used for this purpose. As one example, the CSR may be queried (either on the log-in screen returned in Block 305, or via another screen) to provide location information, such as a machine number which uniquely identifies his or her current location, or perhaps a room number which serves that purpose. As another example, device-specific identifying information may be programmatically obtained from the incoming messages obtained in either or both of Blocks 300 and 310. This device-specific information may comprise a machine serial number, a Media Access Control (“MAC”) address, an Internet Protocol (“IP”) address, or similar information. As yet another example, when the CSR is using an appropriately adapted workstation, the CSR's position may be determined using physical or geographic location information which is obtained using techniques such as cellular phone triangulation or global positioning system (“GPS”) inputs.

At Block 345, the WAL registers information about this CSR and his or her current workstation/position, and preferably creates a cookie (or similar storage record) representing this information. The switch and ACD are preferably informed of the CSR's physical location at this time as well (e.g. for purposes of subsequent routing of calls to this CSR).

The cookie created in Block 345 may also include a CSR-specific polling interval value. Polling intervals were briefly discussed earlier, with reference to encircled element 3 of FIG. 2, and represent a predetermined period of time during which the system checks for arrival of a call for this CSR. Preferably, polling intervals are relatively short intervals of time, such as 20 seconds or 30 seconds. In some embodiments of the present invention, a default polling interval may be specified. In embodiments where the polling interval for each CSR is allowed to vary, then the cookie created in Block 345 preferably stores the CSR's polling interval value; otherwise, a system-wide polling interval may be used (and does not need to be stored in each CSR cookie).

In Block 350, the cookie is returned to the client device (i.e. the CSR's workstation). Using conventional HTTP version 1.1 message exchanges, which are commonly used for client-server communications such as the interactions which support communication between browser 110 and WAL 120 of FIG. 1 in a Web environment, this cookie (or an updated version thereof; see the discussion of Block 390, below) will automatically be returned from the CSR's workstation to the WAL on each subsequent HTTP GET request message or HTTP POST request message until the CSR logs out or the session times out due to inactivity (which is configurable at the Web server level of Web application layer 120). In this manner, the CSR's current position and other information is always available for processing by the WAL, enabling the WAL to continue delivering calls to this CSR even when the CSR moves from one location to another (and also enabling the WAL to associate incoming messages with the CSR).

After the cookie has been returned to the CSR, a wait event is preferably initiated which lasts for the duration of this CSR's polling interval (Block 360). This wait event preferably comprises starting a timer. When the wait event expires (i.e. the timer pops), then processing continues at Block 365 which tests to see if an incoming call is available for this CSR. In preferred embodiments, this comprises sending an HTTP request to a polling servlet executing in a servlet engine (such as the Web application server at WAL 120). As is known in the art, servlet engines are typically programmatically hooked in to Web servers with a plugin which detects requests for certain paths to the Web server, and forwards these requests to the servlet engine which returns a response which goes back out through the Web server. (Alternative embodiments may use code which is not implemented as a polling servlet to perform this check, as will be obvious to one of skill in the art.) In turn, the polling servlet may obtain the requested information (i.e. whether there is a call) by issuing a message call to an application server. In preferred embodiments, an identification of the CSR is passed on the request in order to determine whether a request for this particular CSR is available. (In alternative embodiments, it may happen that all CSRs are equally well trained to handle all incoming call requests. In this case, it is not strictly necessary to pass the CSR identification information; instead, it is sufficient to determine if any incoming call is available.)

If the servlet determines that a call is not pending, the request simply returns. The test in Block 365 then has a negative result, and processing continues at Block 370 which checks to see if the CSR's position has become unavailable. The CSR's position may have become unavailable for any of a number of reasons, such as (a) the CSR is already handling a call, and hence cannot take another call; (b) communication may have been disrupted between the CSR's phone and the ACD; or (c) the CSR may have explicitly indicated his or her unavailability—for example, to take a break—by pressing a “not available” key on the CSR's workstation or via other application-specific means.

If the test in Block 370 has a negative result (i.e. the CSR's position is available), then it can be presumed that the CSR is still in the same position represented by his or her cookie, and control simply returns to Block 360 to wait for the next expiration of this CSR's polling interval. Otherwise, when the test in Block 370 has a positive result (indicating that the CSR's position is not currently available), then the CSR may have moved to a different location or a different workstation. Block 380 therefore checks to see if the CSR has moved. Generally, a CSR who moves to another location will explicitly log off from his or her device/workstation (or, the device/workstation may have failed, necessitating the move) and will also log off from the phone where calls are received from the ACD. Thus, the test in Block 380 preferably comprises checking the stored information about where the CSR is currently located.

If the CSR has not moved (i.e. the test in Block 380 has a negative result), then control returns to Block 360; otherwise (when the test in Block 380 has a positive result), the position information in the CSR's stored cookie is revised (Block 390), after which processing returns to Block 350 to transmit this revised cookie to the client. The switch and ACD are also preferably informed of the CSR's changed location at this time.

Returning again to the discussion of Block 365, if the polling servlet determines that a call is pending, then Block 375 checks to ensure that the CSR for this call is still available. Refer to the discussion of Block 370, above, for a description of scenarios in which a CSR might become unavailable. (The CSR might have logged off while the polling timer was waiting to expire, for example, and thus the test in Block 375 is provided to ensure that data is not unnecessarily retrieved from the back-end systems only to find that the CSR cannot take the call.) When this test has a positive result (i.e. the CSR can take the call), the caller-specific information is retrieved (Block 385) from the back-end systems using CallPath or similar software, as has been described with reference to FIG. 2. (Note that while the description of FIG. 3 discusses obtaining the detailed caller-specific information when preparing to route a call to the CSR, in alternative embodiments this information may be retrieved at an earlier time, such as when the call request is being placed onto the ACD queue. A particular implementation may choose one of these pre-fetch strategies based upon factors such as expected cost trade-offs for the data retrieval and faster availability of the retrieved data for the CSR's use.) The retrieved caller-specific information is placed into the session context for the ongoing session between browser 110 and WAL 120, where it may be used to populate an appropriate Web page in an application-specific manner. The Web page being rendered to the CSR via browser 110 is programmatically re-directed to this populated Web page as the call is being switched to the CSR (Block 395), using the CSR's current position as reflected by the stored cookie. This automatic presentation of the customer's data to the CSR (via a “screen pop” or refreshed display) avoids the CSR having to explicitly ask the customer for information and manually enter that information into a form or data entry screen.

After this call and its data are transferred to the CSR in Block 395, control returns to Block 360 to await the next expiration of the polling interval for this CSR.

The flowchart in FIG. 4 illustrates operation of the present invention, according to a caller's perspective. The processing of FIG. 4 begins at Block 400, where the customer calls the call center (perhaps using a toll-free number), and this call arrives at the call center's switch. When the call is received, the switch then automatically transfers the call to one of the available VRU lines (Block 405). This typically results in a voice prompt being issued (Block 410), requesting appropriate information such as a customer account number. Once the caller enters his or her account number or other requested information (Block 415), a call may be made to a back-end application to retrieve this caller's customer-specific information (as has been described with reference to CallPath software). (Alternatively, the customer-specific information might not be retrieved until preparing the route the call to a CSR, as has been described with reference to FIG. 3.) The retrieved customer-specific information may (optionally) be verified with the customer (Block 420), for example by prompting for a zip code and then matching that zip code to the account number or other identifying information provided in Block 415.

At this point, another call is preferably made to the back-end application at application server tier 140 to check if CSR intervention is needed in handling this request, according to application-specific criteria. If so, the call is transferred to the appropriate department queue or other appropriate queue or storage structure (Block 425). (As an alternative to contacting the back-end application to determine if CSR input is required, the caller could explicitly elect to talk to a CSR, for example by pressing a key sequence such as the “0” key to transfer the call immediately for CSR handling.) Once the call is in a queue, the caller then waits (Block 430) until a CSR is available to receive the call.

When a CSR is available, the call and corresponding data is transferred to that CSR (Block 435). In preferred embodiments, the CallPath product or similar software is used to obtain the customer-specific data that is transferred along with the voice call in Block 435. This process has been described above, and in preferred embodiments is facilitated by calling the CallPath product (through a server application such as a transaction processing monitor, of which the TXSeries™ product from IBM is one example) to associate the account number entered by the caller with the call, creating what is referred to as “call data”, and then performing a blind transfer of the call (that is, the call is transferred without waiting for the called party to respond) to an appropriate one of potentially many department queues. (Which queue to transfer the call to typically depends on information such as the customer account number and/or the toll-free number which was called, or the type of request, or other enterprise-specific factors, as has been described.) This queued data is then transferred along with the voice call to the CSR at Block 435, and the CSR may then use this information while handling the caller's request (Block 440). Following completion of Block 440, the processing of FIG. 4 ends. (“TXSeries” is a trademark of IBM.)

If the “caller” is contacting the call center using a Web-based interaction instead of from a telephone call, then the processing of Block 400 preferably comprises completing a call request form (which may, for example, be displayed on or accessible from a Web site). In this case, the information which is useful for improved handling of the call request, and which would normally be obtained using a VRU, is typically requested directly from the request form. Thus, processing may skip directly to Block 425, which places an entry on an appropriate ACD queue. In preferred embodiments, this entry may simulate an incoming telephone call request: an automated callback to the customer's telephone number may be generated from the call center system when a CSR becomes available. Or, the customer may be asked to provide information as to his or her preferred time for receiving a callback. Web-based interactions of this type are known in the art, and are sometimes referred to as “click to callback”. See http://www.haifa.il.ibm.com/projects/software/callcenter.html on the Internet for a description of a click to callback feature available from IBM.

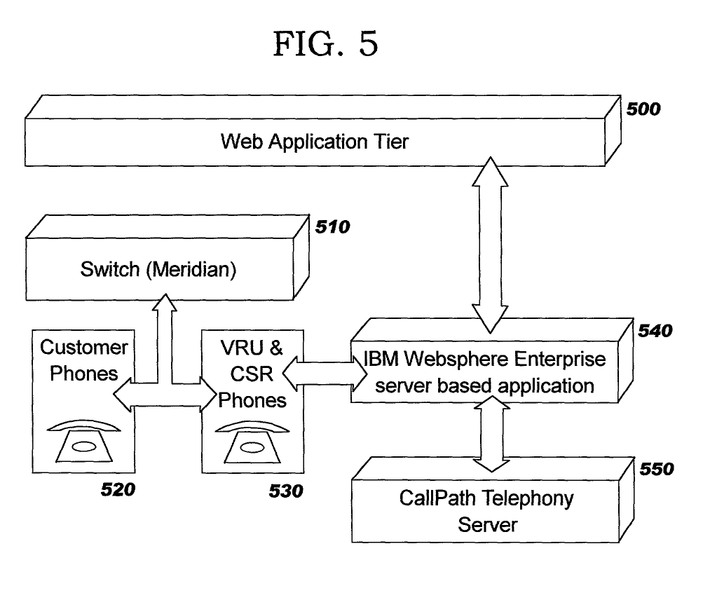

FIG. 5 illustrates components and data flow at a high level, including commercially-available products which may be used to provide selected functions of an implementation of the present invention. Web application tier 500 corresponds to element 120 of FIG. 1, and switch 510, which may be a Meridian switch, corresponds to switch 205 of FIG. 2. Customer phones 520, switch 510, and VRU and CSR phones 530 communicate to accept incoming calls, obtain call data for those calls, queue the calls, and route the calls from the queues to the CSRs. Application server tier 140 of FIG. 1 may be implemented using an IBM WebSphere® Enterprise server-based application 540 and a CallPath telephony server 550. These products exchange information with the VRU and CSR phones 530 (for example, by obtaining the call data for incoming calls) and with the Web application tier 500 (for example, by providing customer-specific information which has been retrieved from the back-end data store). A detailed description of the processing and information exchange between these components has been provided above. Other commercially-available products may be substituted for the components shown at 510, 540, and 550 without deviating from the scope of the present invention. (“WebSphere” is a registered trademark of IBM.)

As has been demonstrated, the present invention provides advantageous techniques for improving call center systems, whereby incoming customer contact requests may be automatically and dynamically routed to a CSR even though that CSR may move from one location to another and/or may work from remote locations. Furthermore, in preferred embodiments, the CSRs may be using thin client devices or may otherwise avoid modifications to their computing devices. Using the Web-centric architecture disclosed herein for distributed call center operations, even though CSRs of a particular call center may now work from more than one location, they are all able to access the same queues and handle call requests from those queues.

The disclosed techniques may also be used to implement improved methods of doing business. For example, call center services using the present invention may be provided to one or more companies by a call center operating in a services hosting paradigm. Customers of these call center services can expect improvements such as increased CSR productivity and shortened caller response time due to the ability of CSRs to handle calls from any location where they have access to a phone and a thin-client workstation.

As will be appreciated by one of skill in the art, embodiments of the present invention may be provided as methods, systems, or computer program products. Accordingly, the present invention may take the form of an entirely hardware embodiment, an entirely software embodiment or an embodiment combining software and hardware aspects. Furthermore, the present invention may take the form of a computer program product which is embodied on one or more computer-usable storage media (including, but not limited to, disk storage, CD-ROM, optical storage, and so forth) having computer-usable program code embodied therein.

The present invention has been described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, embedded processor or other programmable data processing apparatus to produce a machine, such that the instructions, which execute via the processor of the computer or other programmable data processing apparatus, create means for implementing the functions specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart and/or block diagram block or blocks.

While the preferred embodiments of the present invention have been described, additional variations and modifications in those embodiments may occur to those skilled in the art once they learn of the basic inventive concepts. Therefore, it is intended that the appended claims shall be construed to include both the preferred embodiment and all such variations and modifications as fall within the spirit and scope of the invention.

What is claimed is:

1. A method of processing customer contact requests, comprising steps of:
receiving location information from a particular customer service representative (“CSR”) indicating where the particular CSR is currently located;
receiving one or more incoming customer contact requests for which CSR interaction is indicated; and
routing selected ones of the received customer contact requests to the particular CSR using the received location information.

2. The method according to claim 1, wherein the location information from the CSR is received over a network connection between a processing device used by the CSR and a remotely-located server.

3. The method according to claim 2, wherein the processing device used by the CSR is a thin-client device.

4. The method according to claim 2, wherein the CSR interacts with a Web page to transmit the received location information and to handle the routed customer contact requests.

5. The method according to claim 1, further comprising the steps of:
receiving revised location information from the particular CSR, wherein the revised location information indicates a different location where the particular CSR is now located; and
subsequently routing selected ones of the received customer contact requests to the particular CSR using the received revised location information.

6. The method according to claim 2, wherein the received location information is stored for use by the routing step, and further comprising the steps of:
creating a cookie which contains stored information for the particular CSR; and
transmitting the cookie to the CSR over the network connection.

7. The method according to claim 1, wherein the received location information indicates a device which is in use by the particular CSR, and to which the routing step should route the selected ones for the particular CSR.

8. The method according to claim 1, wherein the received location information indicates a geographic location of the CSR.

9. The method according to claim 1, wherein the received location information indicates a physical location of the CSR.

10. The method according to claim 1, further comprising the steps of:
obtaining customer-specific information pertaining to the selected ones of the received customer contact requests; and
forwarding the obtained customer-specific information to the particular CSR when routing the selected ones of the received customer contact requests.

11. A method of providing distributed call center operations, comprising steps of:
receiving, over a network connection to a call center system, location information from one or more customer service representatives (“CSRs”) indicating where each of the CSRs is currently located;
receiving, at the call center system, one or more incoming customer contact requests for which CSR interaction is indicated;
queuing, at the call center system, each of the received customer contact requests until a CSR is available for handling the request; and
routing, by the call center system, a selected one of the queued customer contact requests to a particular CSR using the received location information when the particular CSR is or becomes available.

12. The method according to claim 11, further comprising the steps of:
receiving revised location information from one or more of the CSRs, wherein the revised location information indicates a different location where the CSR sending the revised location information is now located; and
subsequently using the received revised location information when routing a newly-selected one of the queued customer contact requests to one of the CSRs who sent revised location information.

13. A system for providing distributed call center operations, comprising:
means for receiving, over a network connection to a call center system, location information from one or more customer service representatives (“CSRs”) indicating where each of the CSRs is currently located,
means for receiving, at the call center system, one or more incoming customer contact requests for which CSR interaction is indicated,
means for queuing, at the call center system, each of the received customer contact requests until a CSR is available for handling the request; and
means for routing, by the call center system, a selected one of the queued customer contact requests to a particular CSR using the received location information when the particular CSR is or becomes available.

14. The system according to claim 13, further comprising:
means for receiving revised location information from one or more of the CSRs, wherein the revised location information indicates a different location where the CSR sending the revised location information is now located; and
means for subsequently using the received revised location information when routing a newly-selected one of the queued customer contact requests to one of the CSRs who sent revised location information.

15. A computer program product for providing distributed call center operations, the computer program product embodied on one or more computer-usable media and comprising:
computer readable program code means for receiving, over a network connection to a call center system, location information from one or more customer service representatives (“CSRs”) indicating where each of the CSRs is currently located;
computer readable program code means for receiving, at the call center system, one or more incoming customer contact requests for which CSR interaction is indicated;
computer readable program code means for queuing, at the call center system, each of the received customer contact requests until a CSR is available for handling the request; and
computer readable program code means for routing, by the call center system, a selected one of the queued customer contact requests to a particular CSR using the received location information when the particular CSR is or becomes available.

16. The computer program product according to claim 15, further comprising:
computer readable program code means for receiving revised location information from one or more of the CSRs, wherein the revised location information indicates a different location where the CSR sending the revised location information is now located; and
computer readable program code means for subsequently using the received revised location information when routing a newly-selected one of the queued customer contact requests to one of the CSRs who sent revised location information.
